(19) United States
(12) Patent Application Publication
(10) Pub. No.: US 2004/0156954 A1
(43) Pub. Date: Aug. 12, 2004

(54) Crisp microwaveable filled dough product, and methods for making same

(76) Inventors: Peeyush Maheshwari, Plymouth, MN (US); Mary J. Reed, Minnetonka, MN (US); Thomas Craig Hoese, Hopkins, MN (US); Essam Wahbah, Minneapolis, MN (US); Nicholas D. Kovich, Minneapolis, MN (US); Heidi L. Nelson, Burnsville, MN (US); James N. Weinstein, Maple Grove, MN (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 10/360,991

(22) Filed: Feb. 7, 2003

(51) Int. Cl. A23K 1/00

(52) U.S. Cl. 426/97

(57) ABSTRACT

Filled dough products are provided having enhanced crispiness. In one aspect specific crispiness enhancing ingredients are added to either or both the dough composition and the filling composition to provide superior crust performance properties in the final filled dough product. In another aspect, a preferred extrusion die is provided that comprises a primary extrusion opening and a plurality of secondary extrusion openings and is positioned across an outlet of an extrusion passageway. The preferred die further includes at least one recessed region, which at least partially includes a portion of one or more secondary extrusion openings. The present invention is also directed to methods of forming filled food products.

### FIELD OF THE INVENTION

The present invention relates generally to pre-cooked microwaveable pastry systems and to food product extrusion devices. In particular, the present invention is directed to filled food products and food product extrusion dies that provide improved food product flow characteristics through the dies.

### BACKGROUND OF THE INVENTION

Composite food products have become increasingly popular with consumers and are highly desirable. Such food products are generally formed from two or more food components. These food components can have different textures, different moisture content and, different compositions, for example.

One common type of composite food product is a filled food product. That is, a food product where one food component encloses another food component. These include, for example, egg rolls, pizza rolls, burritos, and the like. A typical pizza roll generally includes an outer shell, formed from a dough product, and a filling, which may include a wide variety of ingredients such as cheeses, meats, sauces, etc. Usually, both the outer shell and the filling can be cooked together once the composite food product is formed. Often, filled composite food products, such as these, are cooked and then prefrozen and later prepared by a consumer, usually by reheating.

One difficulty associated with manufacturing a dough shell or crust surrounding a moist filling relates to maintaining product quality after the product has been initially cooked during manufacturing and is then later reheated for consumption. Cooking the product in a fat, such as by frying, during manufacturing imparts a desirable crispiness to the dough shell. The manufactured product is typically then cooled and often frozen for storage and distribution. When the end consumer desires to eat the food product, it is reheated to achieve a desirable temperature. This cooling, or even freezing, and then reheating significantly affects the texture of the food product, especially the original crispness of the dough shell. Specifically, during reheating, there is a significant level of moisture migration from the moist filling into the crisp crust.

Composite food products are particularly convenient because they may be stored in the freezer for fast preparation by the consumer at their convenience. Typically, such products are provided in small portions, so that any number of portions may be readily prepared on demand. While such products may be prepared by heating in a conventional oven, convenience is further provided by heating with a microwave oven. Maintenance of a crisp crust in a composite product is further compounded by the use of alternative heating technologies. More specifically, a conventional oven heats the product from the outside in. In the conventional oven, the outside of the food product receives more exposure to cooking temperatures than the interior of the food product, and a crispy outer coating can be readily attained. In the alternative when a microwave oven is used, the product is heated by excitation of water molecules, essentially heating the food product from the inside out. As a result, there is essentially no surface browning or crusting of the food product when heated in the microwave. The challenge of obtaining a product that will provide the desired organoleptic properties when using either heating technique is indeed formidable.

One approach to solving the problems associated with heating these products is to add a barrier to the composite food product to minimize moisture migration from the moist region to the crisp region. Breading or other dry coatings may provide such a barrier. Another approach has been to use a batter to form an outer coating. Thus, as disclosed in U.S. Pat. Nos. 5,194,271 and 5,520,937, a film batter is prepared that adheres to and uniformly coats the surface of the dough of a dough enrobed food product. A similar such system is described in PCT application WO 99/44428. These formulations require first formation of the food product, followed by application of the crisping batter to the outside of the dough of the food product. This configuration may also provide surface textural properties that are different from the properties of the dough component of the food product. In certain products, this difference in surface texture may be less preferred by certain consumers.

Another approach to this moisture migration problem is described in U.S. Pat. No. 5,538,744 to Miller et al., which is commonly owned by the assignee of the present invention and fully incorporated by reference herein. Miller et al. describes a method for forming a dough structure that has ridges and valleys by using an extruder device. The variable cross-sectional thickness and ridged, thicker region of the dough provide a physical impediment to moisture migration to the outer surface of the dough product, particularly when the product is cooked and then subjected to stresses such as thawing and refreezing or is stored frozen and reheated by a consumer. Because the dough ridges are thicker than the valleys, moisture from the filling has a greater distance to migrate to reach the outer surface of each ridge and may not reach the outer ridge surface when subjected to stresses or during reheating.

Yet another approach this moisture migration problem is described in U.S. Pat. No. 5,965,186 to Hayes-Jacobson et al., which is also commonly owned by the assignee of the present invention and fully incorporated by reference herein. Hayes-Jacobson et al. describes a method for forming a dough product having a filling and having projections extending from the surface of the dough product. The projections serve to isolate a volume of dough away from the main body of the dough product, so the moisture from the filling inside the main body of the dough product cannot readily migrate into the projections. The dough product with its projections attains a significant level of crispness upon frying, and retains the crispness upon reheating, even after a freeze/thaw cycle. Generally, the projections concentrate a volume of dough away from contact with the moist filling located inside the filled product, thereby reducing moisture migration from the filling into the projections, even after one or more freeze/thaw cycles.

Food product extrusion techniques and devices that produce extruded food products having consistent, controllable, and uniform cross-sectional shapes are thus desirable. Moreover, although the above described conventional techniques provide extrusion methods and apparatuses for providing food products with certain cross-sectional shapes, improved extrusion techniques are desirable. This is especially true as consumers desire food products with consistent characteristics, such as crispness, in a precooked and reheated food product, particularly in food products reheated in a microwave oven.

### SUMMARY OF THE INVENTION

The present invention provides a filled dough product with enhanced crispiness that does not require application of a separate crisping component to the outside of the dough component. The resulting product preferably provides a uniform dough component without a separate surface texturizing ingredients. This may particular provide manufacturing advantages, because an extra coating step may be eliminated, while still achieving the desired crispiness effect.

In one aspect of the present invention, it has surprisingly been discovered that the addition of corn meal to the dough composition provides superior crust performance properties in the final filled dough product. In another aspect of the present invention, it has surprisingly been discovered that the addition of a crispness maintenance agent comprising breadcrumbs having an average particle size of from about 1 mm to about 7 mm to the filling composition provides superior crust performance and flavor properties in the final filled dough product. In another aspect of the present invention, it has surprisingly been discovered that the addition of both corn meal to the dough composition and of a crispness maintenance agent comprising breadcrumbs having an average particle size of from about 1 mm to about 7 mm to the filling composition provides superior crust performance properties in the final filled dough product. Preferably, the filled dough product provided format wherein the filling is fully encased in the dough. The addition of these components finds particular advantage in products that are provided to the consumer in a frozen format, with preparation by the consumer through immediate introduction of the product from the freezer to the heating apparatus. A heating apparatus may be any appropriate heating device, such as a conventional oven or a microwave oven.

In another aspect of the present invention, methods and apparatuses for extrusion of food products that comprise projections formed on or extending from a surface of a food product are provided. The methods and apparatuses provide a more accurate rendition of the desired shapes of projections to extend from the surface of the food product, and additionally allow for a faster and more efficient production of the food product because this more accurate rendition is now achievable at higher extrusion rates. More specifically, a method is provided for extruding a food product, comprising providing an extrusion die having an extrusion opening, providing an extrudable food product, and extruding the extrudable food product through the extrusion opening of the extrusion die.

The extrusion die comprises a body portion having first and second sides and a primary extrusion opening formed through the body portion and having an outside surface. A plurality of secondary extrusion openings are formed through the body portion so as to be spaced apart around the outside surface of the primary extrusion opening and extend outwardly from the outside surface of the primary extrusion opening such that the plurality of secondary extrusion openings fluidly communicate with the primary extrusion opening to form a continuous extrusion opening for forming an extruded food product having a predetermined cross-sectional shape. At least one recessed region is formed in the first side of the body portion including at least a portion of at least one of the plurality of secondary extrusion openings. The extruded food product that is formed has an outside cross-sectional shape generally corresponding with the continuous extrusion opening. The method and apparatus as described has been found to provide a filled food product that is crispier than prior art filled food products that do not use the present methods and apparatuses. This benefit is observed using conventional recipes for dough and filling. The use of the present methods and apparatuses in combination with the addition of the crispness enhancing ingredients as describe above to either or both the dough composition and the filling composition result in final filled dough product that exhibit particularly advantageous organoleptic properties.

### BRIEF DESCRIPTION OF THE DRAWINGS

The accompanying drawings, which are incorporated in and constitute a part of this application, illustrate several aspects of the invention and together with a description of the embodiments serve to explain the principles of the invention. A brief description of the drawings is as follows:

FIG. 1 is a side view of a filled dough product of the present invention.

FIG. 2 is an end view of an alternative filled dough product of the present invention.

FIG. 3 is a side view of an alternative filled dough product of the present invention where the filling is fully enrobed.

FIG. 4 is a cross sectional view of the filled dough product of FIG. 3, taken along line 4-4.

FIG. 5 is a schematic view of one embodiment of the food product of the present invention.

FIG. 6 is a perspective view of one embodiment of an extrusion head useful in the method of the present invention.

FIG. 7 is a partial cross-sectional side view of the extrusion head shown in FIG. 6.

FIG. 8 is a perspective view of a die useful in the method of the present invention.

FIG. 9 is a plan view of a first side of the die shown in FIG. 8.

FIG. 10 is a cross-sectional view of the die shown in FIG. 8.

FIG. 11 is a plan view of a second side of the die shown in FIG. 8.

FIG. 12 is a plan view of another embodiment of a die useful in the method of the present invention.

FIG. 13 is a plan view of another embodiment of a die useful in the method of the present invention.

FIG. 14 is a plan view of another embodiment of a die useful in the method of the present invention.

FIG. 15 is a plan view of another embodiment of a die useful in the method of the present invention.

### DETAILED DESCRIPTION

As noted above, it was previously thought that crisping aids had to be located on the outside of a food product to be effective to impart crispiness to a product. Surprisingly, in one aspect of the present invention it has been discovered that use of specific components in either or both the dough composition and the filling composition significantly enhances the crispiness of filled dough products. More specifically, it has been found that the incorporation of cornmeal in the dough composition itself, rather than on the outside of the product, surprisingly enhances the crispiness of filled dough products, particularly when heated in a microwave oven. Additionally, it has been found that the incorporation of a particular quantity of breadcrumbs as a generally mixed component of the filling of the dough product surprisingly further enhances the crispiness of the product.

The phrase “organoleptic properties” as used herein is meant to indicate those properties, whether visual, textural or taste properties that contribute to the overall quality of a dough product. For example, organoleptic properties are typically meant to include such properties as taste, color, smell, texture, shape, appearance, mouthfeel, smoothness, and the like.

The food product of the present invention is a breakfast, lunch, dinner or snack comestible that is a food snack, appetizer, entree or desert product. Examples of such products include egg rolls, pies, pizzas, sandwiches, burritos, popovers, strudels and the like.

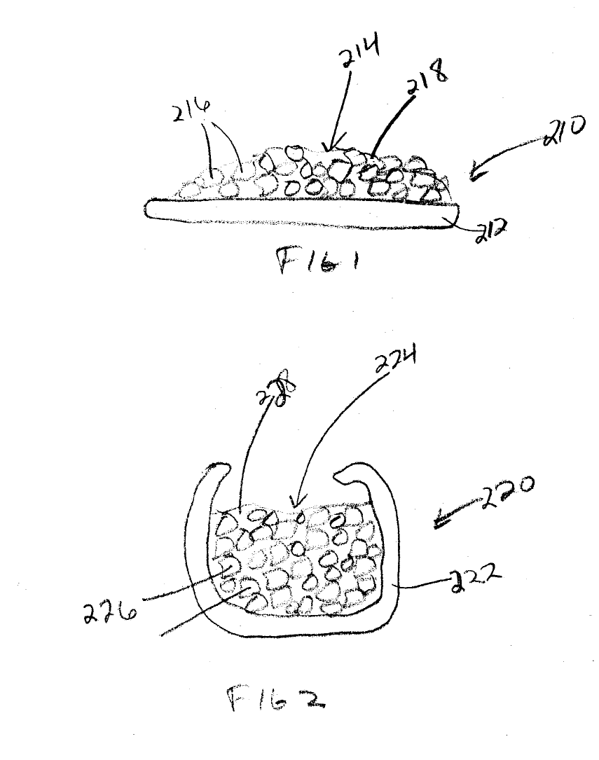

The present invention finds benefit in dough products having filling in close contact with dough. The filling may be place on top of a layer of dough, such as in a pizza format. Preferably, the filling is provided in a format wherein it is partially or completely encased or enrobed in a layer of dough. Turning now to the drawing for further illustration, FIG. 1 is a side view of a filled dough product of the present invention, wherein product 210 is provided with dough layer 212 and filling 214. Filling 214 optionally contains food pieces 216, which may be meat, vegetable, cheese or other suitable food portions as desired for flavoring and nutrition appropriate for the particular food product embodiment. Filling 214 further contains sauce component 218 as desired for flavoring and nutrition appropriate for the particular food product embodiment. The embodiment shown in FIG. 1 has a substantially flat configuration, with the filling 214 resting atop the layer of dough 212.

FIG. 2 is an end view of an alternative filled dough product 220 of the present invention. Product 220 is curved in shape, providing a container format much like a taco or other such partially enrobed food product. The shape of the food product may be adapted as desired to form a bowl or other appropriate receptacle for at least partially containing filling 224. As above, filling 224 optionally contains food pieces 226, which may be meat, vegetable, cheese or other suitable food portions as desired and sauce component 228, both provided as desired for flavoring and nutrition appropriate for the particular food product embodiment.

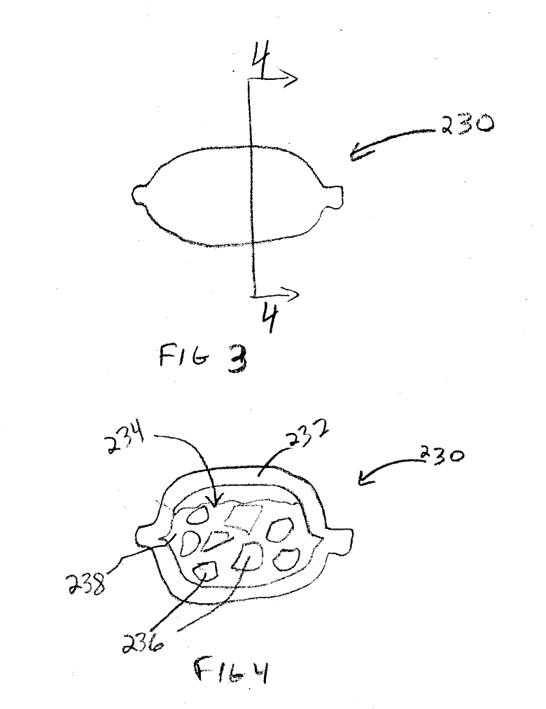

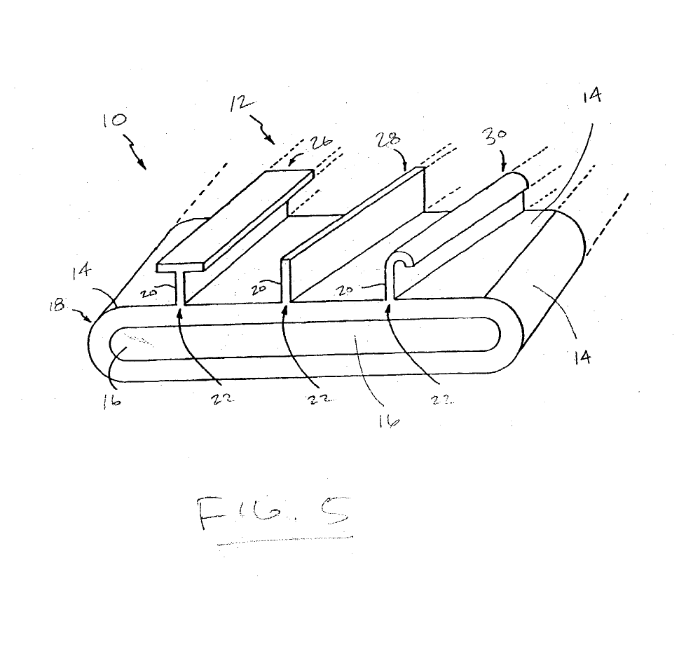

FIG. 3 is a side view of an alternative filled dough product 230 of the present invention where the filling is fully enrobed. FIG. 4 is a cross sectional view of the filled dough product 230 of FIG. 3, taken along line 4-4. Filling 234 is contained within layer of dough 232. As above, filling 234 optionally contains food pieces 236, which may be meat, vegetable, cheese or other suitable food portions as desired and sauce component 238, both provided as desired for flavoring and nutrition appropriate for the particular food product embodiment.

The dough formulation to be used in one aspect of the present invention may be any appropriate dough for consumption together with a filling, provided that the dough formulation comprises flour, water, and additionally comprises corn meal. Typically, dough is made of flour and water, with the addition of minor ingredients, such as fat or emulsifier, to aid the processing or organoleptic properties of the dough. Preferably, the dough is made from about 60 to 80 weight percent flour, 15 to 30 weight percent water, 0 to 7 weight percent fat or oil and 0 to 1.5 weight percent of an emulsifier. Preferably, the dough has a moisture content ranging from between about 25 to about 35 percent by weight (hereinafter designated as “wt-%”). The dough may be made with any flour including wheat, corn, oat, soy, rice, potato and the like. Preferably, the flour has a protein content suitable to make an extrudable dough, ranging from about 10 to 20 wt-% of the flour, more preferably between about 12 to 14 wt-% of the flour. Protein may also be added to the dough to aid in its processability.

Additional ingredients in amounts ranging from 0 to 20 weight percent may be added to the dough to enhance the flavor or other organoleptic qualities of the product. Additional ingredients include flavoring agents, coloring agents, preserving agents, stabilizing agents, nutrients, fortifying agents, dough conditioners, emulsifiers, protein, fat, water binding agents, leavening agents, browning agents, crisping agents, bulking agents and the like. It has been surprisingly been found that, while fat is a desirable component, the incorporation of more than about 2.5% has negative impact on crispness. Preferably, fat is provided as an ingredient of the dough a range from 0-2.5% by weight of the total dough composition.

As noted above, corn meal is provided in the dough formulation in an amount to enhance the crispness of the final product after heating in the microwave as compared to a like formulation not containing corn meal. Preferably, corn meal is present from as from about 0.1 to about 10% of the dough formulation by weight. More preferably, corn meal is present as from about 1 to about 10%, and most preferably as from about 2.5 to about 5% of the dough formulation by weight. The corn meal to be incorporated in the dough formulation of the present invention may be any corn meal such as is commercially available in the industry. Preferably, the corn meal has a moisture content of less than about 14%. The corn meal may be provided in any particle size distribution effective in enhancing the crispness of the dough portion of the filled dough product. The maximum particle size is primarily dictated by the desired organoleptic properties of the filled dough product and practicalities of manufacture. Thus, it is contemplated that extremely large corn meal particles may detract from the desired textural sensation of the dough portion during eating of the product by the consumer. Additionally, extremely large particles may cause processing problems if the product is made by an extrusion process. Extruded product therefore desirably contains corn meal having particle sizes that are no larger than 75% of the die opening through with the dough is to be extruded. Preferably, the corn meal has an average particle size of between about 250 and 600 microns. Most preferably, the corn meal has a granulation size distribution such that no more than about 3% of the granules by weight do not pass through a USBS #20 sieve, no more than about 10% of the granules by weight do not pass through a USBS #30 sieve, and a maximum of abut 7% of the granules by weight pass through a USBS #60 sieve.

In a particularly preferred embodiment, titanium dioxide is additionally provided in the dough formulation of the food product in an amount of about 0.0 to about 5% by weight. Surprisingly, this amount of titanium dioxide has been found to enhance the appearance of the product without detriment to the other organoleptic properties of the product. While not being bound by theory, it is believed that the titanium dioxide acts to absorb excess oils or other components that adversely affect the appearance of the product upon heating of the product in the microwave oven, and/or tends to make the dough component more opaque, thereby improving the appearance of the filled dough product. While prior art filled dough products may appear to be translucent or oily, preferred embodiments of the present invention comprising titanium dioxide as a component of the dough composition are pleasingly golden brown in appearance after being cooked without an appearance of translucency or oiliness. The dough composition is prepared by mixing the ingredients as described above in conventional mixing equipment known in the baking arts. The dough may be made by a batch process, or continuous process, as will be appreciated by those of ordinary skill in the art.

The filling to be used in one aspect of the present invention may be any filling appropriate for consumption together with a cooked dough layer, provided that the filling comprises breadcrumbs as described herein. The filling may incorporate any type of sweet or savory filling ingredients suitable for the desired organoleptic experience of the particular food product. Examples of savory ingredients include but are not limited to meat, vegetable, and dairy ingredients (including flavored butter components). As one example, a particularly desired food product may be positioned as a breakfast food, and would comprise filling ingredients such as eggs, bacon, and cheese. Another desired food product may be a fruit pie dessert product, which would comprise fruit fillings such as cherries, strawberries, blueberries, blackberries, bananas, apples, peaches and the like. Yet another desired food product may be a sweet dessert food product comprising fillings such as fruits, custards, chocolates, icing, honey and any number of other common pie-type fillings. Food products intended for use as entree or side dish uses may preferably comprise meat fillings including chicken, turkey, beef, and the like and/or vegetables such as corn, carrots, spinach, beans, peas, green peppers and the like. Particularly preferred savory fillings comprise cheese fillings, tomato paste sauces such as Italian sauces, and meat flavored gravies. Most preferred fillings comprise ingredients typically contained in pizza, including tomato based sauces, cheese, certain vegetables and meats, with pepperoni and sausage meats most preferred.

Both savory and sweet ingredients may further include spices, herbs, flavoring agents, fats, and the like. The filling may further include such ingredients as preservatives and consistency modifiers such as emulsifiers and thickening agents.

A crispness maintenance agent comprising breadcrumbs is provided in a preferred aspect of the present invention. It has surprisingly been found that incorporation of the crispness maintenance agent in the filling as described herein enhances the crispness of the final product. While not being bound by theory, it is believed that the crispness maintenance agent acts to reduce moisture migration from the filling to the dough, thereby improving the crispness of the final product, particularly when heated in a microwave oven. Additionally, it has been found that the crispness maintenance agent surprisingly reduces boil out of the filling, particularly when the food product is heated in a microwave oven. It has also been found that the crispness maintenance agent surprisingly assists in retention of flavor in the filling during the heating process. While not being bound by theory, it is believed that the crispness maintenance agent assists in retention of volatile components, and particularly volatile flavor components, during the heating process. Such volatile flavor components are particularly at risk of being lost from the filling during microwave heating, due to the “inside-out” nature of the heating process with high heat being experienced by the internal filling components first.

The breadcrumbs to be used in the filling of the present invention may be crumbs from any bread source comprising a hydrogenated or partially hydrogenated oil or shortening component in an amount effective to allow the crumbs to remain as loose particles when hydrated. Thus, the source of the breadcrumbs may be any bread source, including wheat, rye, and the like. The bread may be a fresh or stale bread. Preferably, the breadcrumbs comprise hydrogenated shortening as the hydrophobic component. Preferably, the breadcrumbs comprise 0.01 to about 5%, and more preferably about 0.5 to about 2% of the hydrogenated or partially hydrogenated oil or shortening component. Most preferably, the breadcrumbs comprise about 0.5 to about 2% of the hydrogenated or partially hydrogenated oil or shortening component. Particularly preferred hydrogenated or partially hydrogenated oil or shortening components are selected from partially hydrogenated cottonseed oil, corn oil or canola oils. Most particularly preferred hydrogenated or partially hydrogenated oil or shortening components are hydrogenated soybean oils. Breadcrumbs to be used in the present invention preferably have a moisture content of from about 2.9% to about 7.9%, and a bulk density (grams/cc) of from about 0.35 to about 0.52. Preferably, the bread crumbs to be used in the present invention exhibit a water holding capacity of about 114 to about 267. Water holding capacity is a measurement of the maximum amount of water that may be absorbed by the bread crumbs, measured as the grams of water absorbed divided by the grams of dry bread crumb, reported on a percentage basis. The filling is prepared by mixing and cooking techniques generally known in the art. Portions of the filling may optionally be precooked prior to mixing together with other portions of the filling. The breadcrumbs are preferably added late or last in the manufacturing process, so that the breadcrumbs are not saturated with water or other liquid components of the filling composition in the final product. Most preferably, the bread crumbs are added so that no more than about 4-8 minutes remain in the mixing process in the preparation of the final filling. It has been found that if the breadcrumbs are added too early, the filling becomes too viscous and it is difficult to blend other ingredients to provide an evenly mixed filling composition.

Other additives that may optionally be utilized in the fillings of the present invention include, for example: salt; whiteners, such as titanium dioxide; anti-microbial agents, such as potassium sorbate, sorbic acid, dehydroacetic acid, sodium benzoate, and the like; buffers; food acids; preservatives; antioxidants, such as butylated hydroxytoluene, butylated hydroxyanisole, and the like; as well as vitamins and minerals.

In a particularly preferred embodiment of the embodiment of the present invention, the product has projections as described in U.S. Pat. No. 5,965,186, wherein the total surface area of the dough product with projections of the present invention is significantly greater than that of a dough product without projections. The projections can increase the surface area by any amount depending on the desired crust texture, thickness, shape, size, overall appearance and manufacturing limitations of the product. The total surface area of the dough product of the present invention is preferably increased by between about 200-700%, and is more preferably increased by about 200-400%, compared to the same volume of dough without projections. While not being bound by theory, it is believed that the increased surface area in the form of projections results in increased contact between the frying oil and the dough, thereby increasing crispness of the dough product. Alternatively, the projections may minimize the migration of moisture from the filling to the dough component because more of the dough component is less proximate to the moist filling.

The filling is assembled together with the dough composition by any appropriate steps required to construct the final dough product. Optionally, the dough may be shaped and cooked prior to assembly with the filling. Preferably, the dough is shaped prior to or simultaneously with the addition of the filling to assemble a final product, and the dough portion or the entire dough product is at least partially cooked to provide a pre-cooked dough product.

In one technique of assembly, the dough composition may first be sheeted and cut into separate portions, a filling deposited thereon, and the sheeted dough portion folded over and optionally crimped to contain the filling therein. Alternatively, the dough composition may first be sheeted and cut into separate portions and a filling deposited thereon. A second sheet of dough composition may be disposed over the deposited filling and optionally crimped together, thereby containing the filling portion in a laminar fashion. The separate portions are optionally treated, for example, by spraying with water to enhance the adhesion of the sheets of dough to each other, thereby containing the filling within the dough. In yet another alternative, the dough may be provided as a portion, with the filling injected in the middle of the dough portion by using a needle or other appropriate injection mechanism. In other constructions, the dough composition may be sheeted and have a filling applied thereto as a layer, and the dough/filling laminate rolled together and cut into separate portions to form a spiral shaped filled dough product.

In a preferred embodiment, the dough composition may be coextruded with the filling to provide a filling surrounded by a tubular form of dough composition. This coextruded construction may be cut into separate portions, and optionally crimped to partially or completely encase the filling therein. Optionally, the surface of the filled dough product may be scored or otherwise provided with patterns to provide a unique expansion shape upon baking, or otherwise to provide an aesthetically pleasing final product. In a particularly preferred embodiment, the dough is provided with ridges or projections as discussed above. These ridges or projections may be imparted to the dough at any appropriate time in the assembly process, preferably during the initial formation of the shape of the dough. In one preferred embodiment of the present invention, the filling is partially enrobed in the dough. In other preferred embodiments of the present invention, the filling is fully enrobed in the dough. Other configurations of dough and filling will be readily appreciated by those of skill in this art.

In another aspect of the present invention, methods and apparatuses for extrusion of food products that comprise projections formed on or extending from a surface of a food product are provided. Generally such projections can be used for, on, or with certain food products that are desired to be crispy upon reheating. For example, food products such as pizza rolls and the like desirably comprise a crispy dough shell filled with a generally soft and moist filling. Usually these products are fully cooked by the manufacturer, frozen, packaged, and provided to the consumer for consumption, usually after thawing and reheating, such as in a microwave or the like. It is important to a consumer that a product such as a reheated pizza roll, for example, has a crispy outside and a generally soft inside.

One approach to providing a food product that will have a crisp outer surface upon reheating, such as the food product 10 shown in FIG. 5, is to form projections or ridges 12 on a surface 14 of the food product 10. Due to the projections 12 that extend from the surface 14 of the food product 10, the product is able to maintain its crispness even after a cooling/reheating or freeze/thaw cycle. While not being bound by theory, it is believed that the projections 12 concentrate a volume of dough away from contact with a moist filling 16 inside a main body 18 of the food product 10, which reduces moisture migration from the filling 16 into the projections 12, even after one or more freeze/thaw cycles.

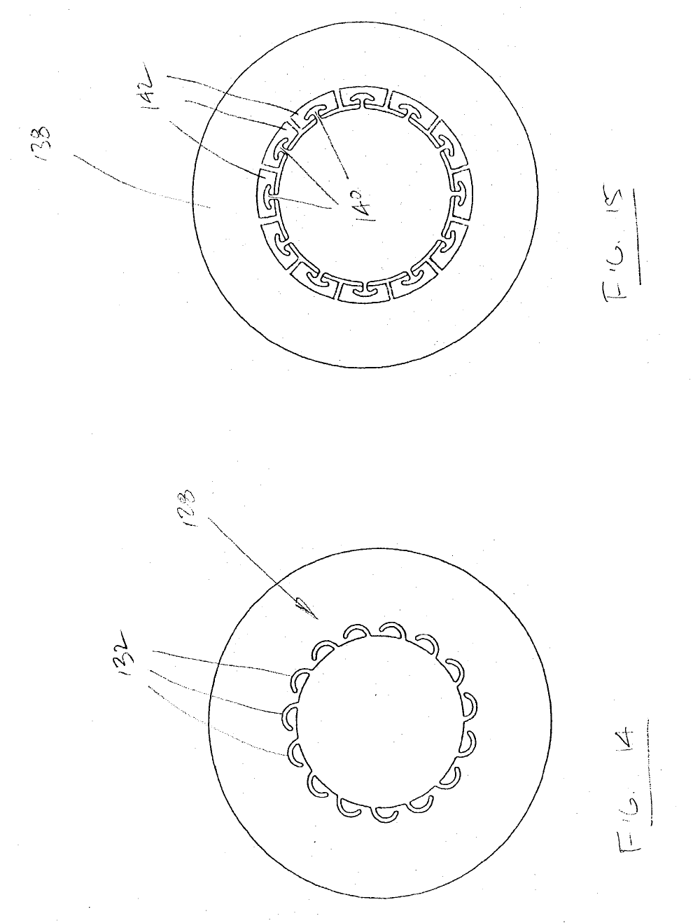

The projections 12 shown in FIG. 5 include an outwardly extending portion 20, attached to the outer surface 14 of the food product 10. The outwardly extending portion 20 has a contact area 22 in contact with the outer surface 14 of the dough. As described in more detail below, projections of this type may be formed by advantageously extruding food product through an extrusion die of the present invention. For example, a food product having projections such as T-shaped projections 26 may be formed by using a die 100 as shown in FIG. 8. A food product having projections such as projections 28 may be formed by using a die 126 as shown in FIG. 13. And, a food product having hook-shaped projections such as projections 30 may be formed by using a die 128 as shown in FIG. 14. It is noted that the relationships and measurements for the projections 12, their vertical components, and any other components may be used to define extrusion openings formed in extrusion dies, as described below.

Preferably, the projections 12 have a geometry and a surface area to volume relationship such that the projections can absorb a greater amount of fat, and simultaneously lose a greater amount of water, during frying, than the other portions of the food product 10. While not being bound by theory, it is believed that these characteristics impart a crisper characteristic to the projections 12 as will be described further. Additionally, because the projections can absorb a greater amount of fat during frying, the resulting high fat concentration in the projections 12 can act as a hydrophobic moisture barrier. The high fat concentration in the projections can serve thereby not only to hinder moisture migration from the filling, but also from the environment surrounding the product. The projections can retain their low moisture and crisp texture as a result, even after the product is frozen and reheated or subjected to freeze/thaw stress.

The projections 12 preferably have a geometry that minimizes contact area 22. As such, moisture migration from the moist filling 16 to the outer surface 14 can be minimized. The contact area 22 should, however, be of sufficient dimension to securely attach each projection 12 to the outer surface 14 of the dough main body 18.

If the projection includes another component in addition to the vertical component, it can be of any size or shape that will retain crispness. The additional components are selected so that they can be extruded or otherwise imparted on the surface of the dough product and will remain on the surface during processing and subsequent handling. Preferably, the additional components are selected so as to provide a volume of dough positioned away from the main body, connected to the product only by virtue of the vertical component. Positioning the dough away from the main body results in the improved crispness characteristics. As described below, the extrusion dies of the present invention enable extrusion of robust, well defined, and generally narrower projections on a surface of a dough product.

It is desirable to provide as much surface area to the projections as possible, preferably at least about 55% of the total dough product surface area. In one embodiment, the projections should make up from about 75% to about 85% of the total dough surface area. While not being bound by theory, it is believed that the increased surface area in the form of projections results in increased contact between the frying oil and the dough, thereby increasing crispness of the dough product. Accordingly, the above-described factors may be utilized in defining the size and shape of an extrusion opening for an extrusion die.

The surface area to volume relationship of the projections also enhances their crispness and ability to maintain crispness. That is, it is desirable to maximize the exposed surface area to volume ratio of the projections to maximize the amount of dough in contact with the frying oil. As the surface area to volume ratio of the projection increases, it is believe that the rigidity or crispness of the projection increases during frying. However, the surface area to volume ratio of the projections should not be high enough to cause the projection to become so thin and brittle during frying that it easily breaks off from the main dough body. Upon reheating the cooked product, it is believed that the surface area to volume relationship of the projections also enhances their ability to dry out and lose moisture that may have migrated into the projections after the product was initially cooked, thereby regaining a crisp attribute. Preferably, the projections include more than about 30% of the total extruded dough volume, but are not so large as to come off of the main body 18 during extrusion or handling. In one embodiment, between about 34% to about 45% of the total dough volume is in the projections. Preferably, the exposed surface area to volume ratio of the projections is greater than about 50 (inches²/inches³), and more preferably ranges from about 55 to about 65 (inches²/inches³).

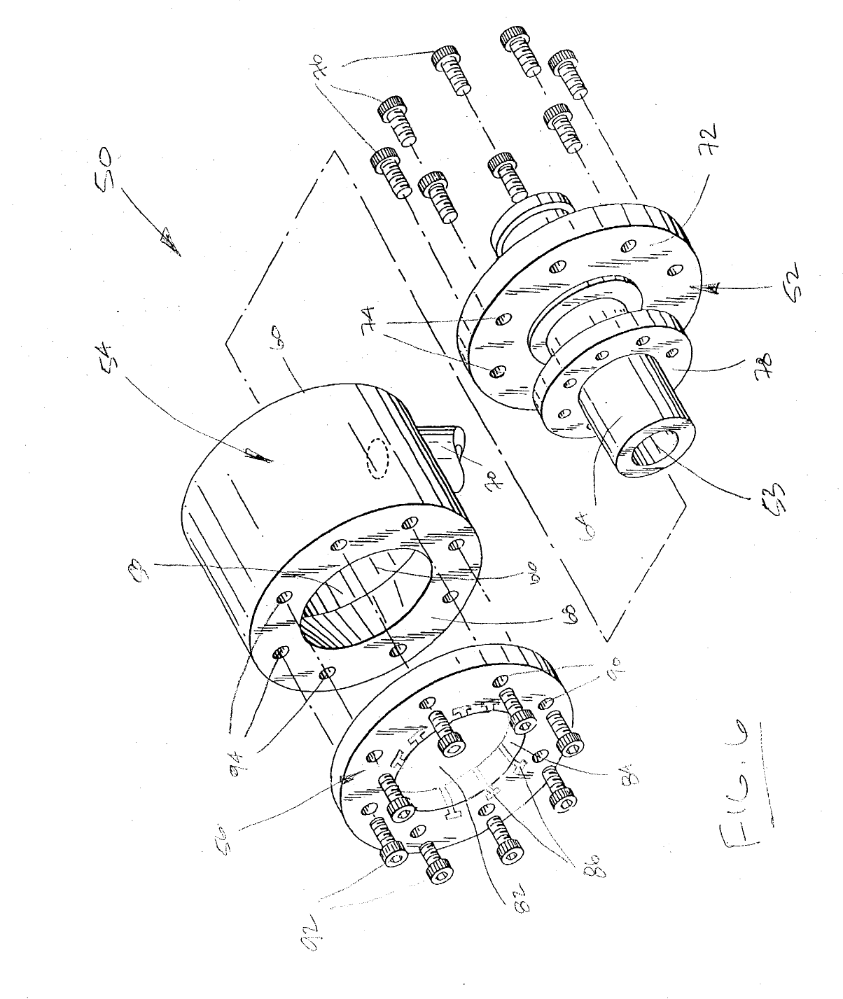

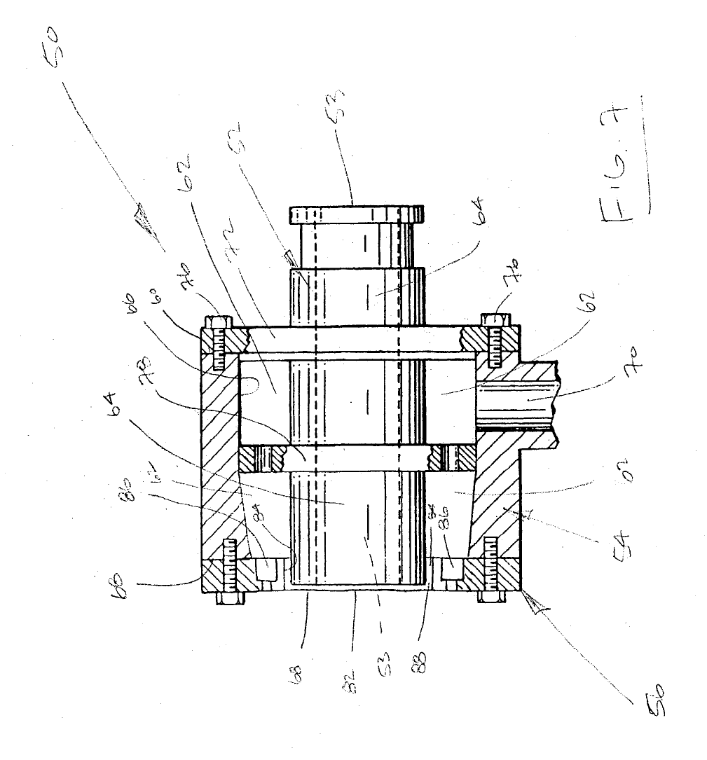

One exemplary extrusion head 50, in accordance with the present invention, is illustrated in FIGS. 6 and 7 and may be used to form a food product such as the food product 12. In particular, FIG. 6 shows an exploded perspective view of the exemplary extrusion head 50 and FIG. 7 shows a partial cross-sectional view of the extrusion head 50. Extrusion head 50 is preferably a co-extrusion head such that a first extrudate, such as a dough, and a second extrudate, such as a filling, can be combined to produce an edible, center-filled food product such as a pizza roll or the like.

Generally, as shown, the extrusion head 50 preferably includes a nozzle 52, a housing 54, and an extrusion die 56. Preferably, the housing 54 includes a central cavity 58. The cavity 58 of the housing 54 opens at a back end 60 for insertion of the nozzle 52 into the housing 54. With the nozzle 52 positioned in the housing 54, a passageway 62 (see FIG. 7) is formed between an outside surface 64 of the nozzle 52 and an inner wall 66 of the housing 54. The cavity 58 of the housing 54 opens at an exit end 68 for attachment of the die 56 and exiting of the extruded food product. The housing 54 further includes a supply port 70 for supplying the first extrudate, which is in fluid communication with the cavity 58.

The nozzle 52 preferably includes a passageway 53 through which the second extrudate can pass. A flange 72 extending outwardly from the outside surface 64 of the nozzle 52 forms an end wall of the extrusion head 50 when the nozzle 52 is positioned in the housing 54. The flange 72 has a plurality of coupling holes 74 equally spaced around the nozzle 52 for receiving screws 76 for removably coupling the nozzle 52 to the housing 54. A distribution flange 78 extends outward from the outside surface 64 of the nozzle 52 to the inner wall 66 of the cavity 58 of the housing 54 for supporting and centering the nozzle 52 within the housing 54. The distribution flange 78 is positioned on the nozzle 52 such that it is generally between the flange 72 and the exit end 68 when inserted within the housing 54. The distribution flange 78 has a plurality of distribution holes 80 equally spaced around the nozzle 52 through which the first extrudate is forced.

Preferably, the die 56 is positioned across and is removably attached to the exit end 68 of the housing 54. The die 56 includes a primary extrusion opening 82 forming an inner surface 84. Additionally, the die 56 preferably includes a plurality of secondary extrusion openings 86. The opening 82 extends around the nozzle, when the die 56 is positioned on the extrusion head 50. An annulus 88 is formed between the outside surface 64 of the nozzle 52 and the inner surface 84 of the die 56 for extruding the first extrudate and forming the shell of the extruded product. The die 56 also preferably includes a plurality of coupling holes 90 equally spaced around the extrusion opening 82 for receiving screws 92 for removably coupling the die 56 to threaded holes 94 on the housing 54. It is noted, however, that the die 56 may be coupled to the housing 54 by any technique such as by using clamping devices or may be permanently attached to the housing 54.

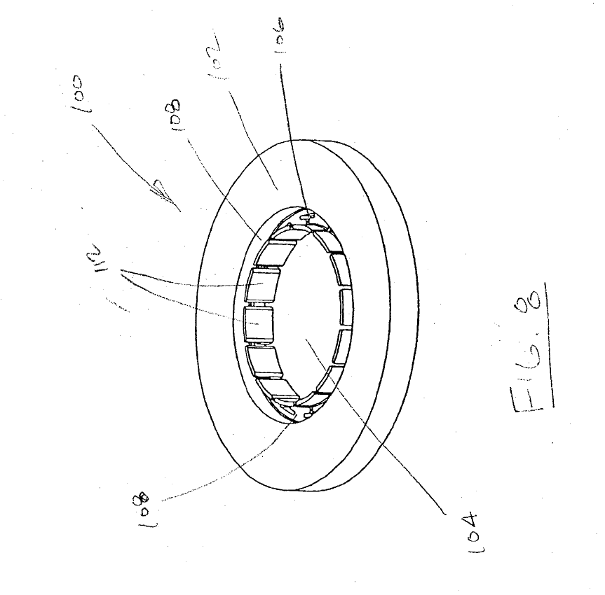

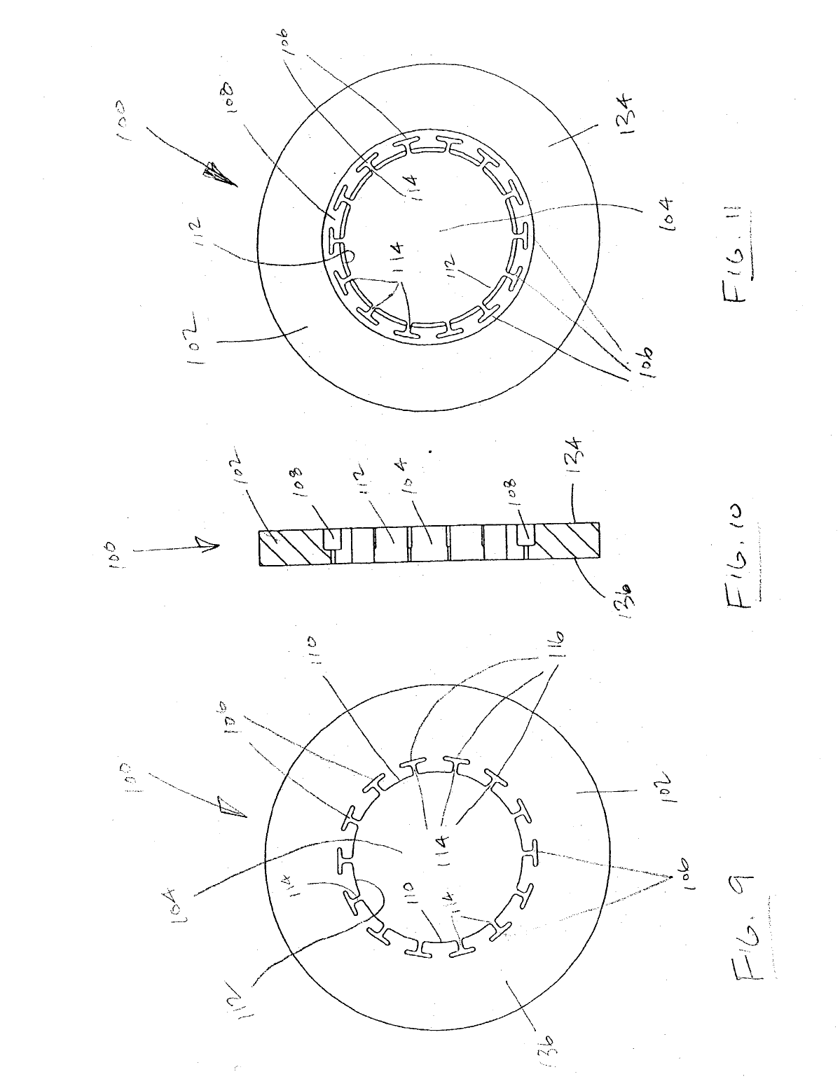

Referring to FIGS. 8-11, one exemplary preferred extrusion die 100 of the present invention is shown, which die 100 may advantageously be used to extrude a food product such as a filled dough product having projections on a surface of the dough product for improving crispness of the dough product, especially upon reheating. Generally, FIG. 8 shows a perspective view, FIG. 9 shows a front view, FIG. 10 shows a cross-sectional side view, and FIG. 11 shows a rear view of the die 100. As shown, the die 100 includes a body 102, a primary extrusion opening 104, a plurality of secondary extrusion openings 106, and a recessed region 108, each of which are discussed in more detail below.

Preferably, the die 100 is adaptable to an extrusion device such as the extrusion device 50 described above. The die may be formed from any materials suitable for contact with food contact and structurally able to maintain its shape under extrusion force pressures. Examples of such materials include metals such as stainless steel, plastics such as Delrin® resins, and combinations thereof. Optionally, the die may be a metal structure that has been coated with a coating approved for contact with food, such as a Teflon® coating material. Moreover, the die 100 may be coated, hardened, or otherwise treated to control properties such as frictional properties as well as thermal, strength, and cleanliness properties, and the like. For example, the die 100 may be polished or coated to reduce friction of food products with respect to the die 100.

Preferably, the primary extrusion opening 104 of the die 100 is formed as an opening through the body 102 and has a size and shape generally corresponding to a size and shape for a desired product. As shown, the primary extrusion opening 104 defines a perimeter 110 (generally circular for the exemplary die 100) and an inside surface 112 (generally cylindrical for the die 100). The primary extrusion opening 104 may comprise any size and shape for forming an extruded food product such as circular (as shown), elliptical, square, rectangular, triangular, as well as combinations of the above. It is noted, however, that a size and shape of a food product extruded from the die 100 may change during subsequent processing of the food product. For example, the die 100 may be used to coextrude a dough product such as a pizza roll, or the like, as a circular filled tube. The filled tube is typically further processed by compressing or stamping or the like to form individual pizza rolls having an oval or squashed profile.

Preferably, the plurality of secondary extrusion openings 106 are also formed as openings through body 102. As shown, the secondary extrusion openings 106 of the die 100 extend outwardly from the surface 112 and are arranged regularly around the perimeter 110 of the primary extrusion opening 104. As such, the secondary extrusion openings 106 are in fluid communication with the primary extrusion opening 104. Each secondary extrusion opening 106 of the exemplary die 100 includes, as shown, a first outwardly extending portion 114 and a second portion 116, which second portion 116 is in fluid communication with the first portion 114, and which is preferably generally perpendicularly oriented with respect to the first portion 114. As such the first portion 114 and the second portion 116 form a T-shaped opening in the body 102 of the die 100.

Preferably, the secondary extrusion openings 106 are formed to obtain extruded projections on a surface of a food product, such as the projections 26, 28, and 30 shown in FIG. 5 and described above. The size and shape of the secondary extrusion openings 106 preferably correspond with the size and shape of a desired projection to be formed on a food product either as extruded or after subsequent processing such as cooking. The parameters described above for defining preferred projections may be used to define the secondary extrusion openings. Many shapes for the secondary extrusion openings 106 are contemplated such as the T-shaped opening of the die 100.

The present invention provides a recessed region, such as the recessed region 108 of the die 100, positioned with respect to secondary extrusion openings for controllably balancing the flow of food product through a primary and plural secondary extrusion openings in accordance with the present invention. Referring to FIG. 8, the exemplary recessed region 108 is formed as a circular channel in the body 102 of the die 100 but alternatively may comprise plural recessed regions. Preferably, the recessed region 108 is aligned with the secondary extrusion openings 106 such that the recessed region 108 includes or overlaps at least a portion of each of the plurality of secondary extrusion openings 106. That is, preferably, at least a portion of a secondary extrusion opening passes through a portion of the recessed region. As such, the extrusion distance for the secondary extrusion opening 106, which corresponds with the thickness of the body 102 where a secondary extrusion opening passes through the body 102 and the recessed region 108, can be adjusted independently from the extrusion distance for the primary extrusion opening 104 to optimize the flow of product through the extrusion die 100. By reducing the extrusion distance for a secondary extrusion opening, frictional resistance of food product moving through the secondary extrusion opening may be reduced such that food product flow through the die can be better controlled and balanced. As such, narrower secondary extrusion openings, which typically can provide greater resistance to food product flow, may be used and a food product having improved crispness upon reheating can be formed.

Again referring to FIGS. 6 and 7, preferably, the recessed region 108 is formed in a supply side 134 of the die 100. That is, food product is preferably supplied to the supply side 134 of the die 100, extruded through the primary 104 and secondary extrusion openings 106, and then exits from an extrusion side 136 of the die 100. The recessed region 108 may thereby provide a guiding or directing function for food product supplied to the recessed region 108. It has been observed that the recessed region can improve the amount of dough that is forced into or fills the secondary extrusion openings 106, especially for generally narrower openings, thereby resulting in better formed extruded projections and an improved product. It is contemplated, however, that the recessed region 108 may be formed in the extrusion side 136 of the die 100 or in both the supply side 134 and the extrusion side 136 of the die. A recessed region formed in the extrusion side 136 or a recessed region formed in both the extrusion side 136 and the supply side 134 advantageously controllably reduces the extrusion distance for the secondary extrusion openings 106 without comprising the structural characteristics of the body 102 of the die 100 and thereby providing less contact area for a food product moving through the die 100. An extrusion die such as the die 100 can experience high pressure and generally may need a minimum thickness, depending on material to withstand such extrusion pressure. The present invention allows for a portion of a die to have a reduced thickness for minimizing friction resistance to food product moving through the die without sacrificing strength of the die itself.

The depth of a recessed region may be determined by trial and error. More specifically, empirical techniques may be used to determine the shape, dimensions, quantity, and spacing for the secondary extrusion openings as well as the depth (which determines the extrusion length of a recessed region) for a particular extrusion process. Each of these parameters can be adjusted and optimized for a specific extrusion process to obtain a desired extrusion rate and product characteristics. Moreover, the depth of a recessed region may be variable. For example, the depth of a recessed region may increase or decrease across the width of a recessed region to form a tapered surface or region. Such a tapered surface or region may advantageously be used to direct or guide food product into the secondary extrusion openings and thereby providing improved filling of the secondary extrusion openings for certain food products such as those having relatively high viscosity and resistance to flow. In other words, the thickness of the body 102 corresponding with a recessed region may be tapered, sloped, angled, curved, etc. to controllably direct the flow of food product through an extrusion die.

It is noted that a single recessed region may be used for all of the secondary extrusion openings of a die or plural recessed regions may be used for each secondary extrusion opening or for multiple secondary extrusion openings. For example, referring to FIG. 15 another exemplary die 138 is shown. The die 138 includes a plurality of secondary extrusion openings 140. As shown, each secondary extrusion opening 140 includes a recessed region 142 that overlaps with a portion of its secondary extrusion opening 140.

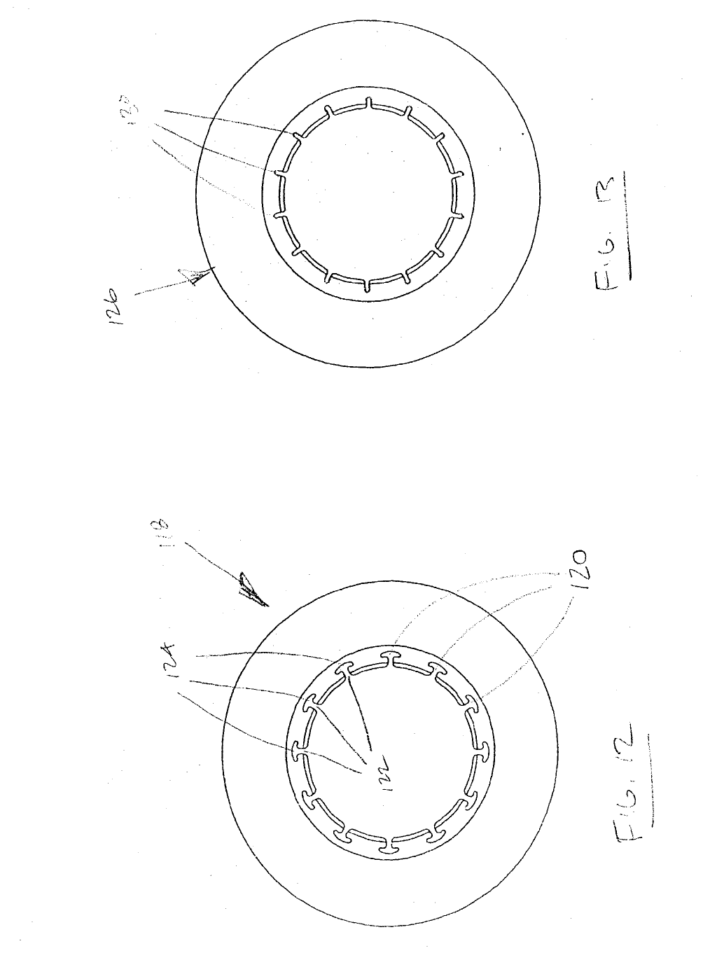

In FIG. 12, another preferred die 118 is shown, which comprises a plurality of secondary extrusion openings 120 that are also generally T-shaped. Each of the secondary extrusion openings 120 of the die 118 includes a first outwardly extending portion 122 and a second curved portion 124 in fluid communication with the first portion 122. Generally, the first portion 122 is radially oriented with respect to the second curved portion 124, as illustrated. Also, in FIGS. 13 and 14, additional exemplary dies 126 and 128, are shown. The die 126 includes secondary extrusion openings 130 comprising a single outwardly extending portion and the die 128 includes secondary extrusion openings 132 comprising a curving outwardly extending portion.

Accordingly, the dies 100 and 118 may be used to form food products having generally T-shaped projections on a surface of the food product such as the projection 26 shown in FIG. 1. The die 126 may be used to form projections such as the projection 28 shown in FIG. 1 and the die 128 may be used to form projections such as the projection 30 shown in FIG. 1. It is noted that an extrusion die in accordance with the present invention may include a plurality of secondary extrusion openings having the same shape or may include a plurality of extrusion openings having different shapes. Furthermore, any number and spacing, either regular or irregular, for the secondary extrusion openings around the primary extrusion opening may be used to achieve a desired crispness for a food product extruded from an extrusion die in accordance with the present invention.

It has been found that the improved extrusion die having a recessed region as described above provides particular benefit in making dough products having a configuration particularly suited for making crispy food products. Substantial benefit is provided in the improved extrusion die, even for filled dough product formulations that do not contain corn meal in the dough composition and/or bread crumbs in the filling composition as described above. It has further been found that the use of corn meal in the dough composition in combination with the improved extrusion die, the use of bread crumbs in the filling in combination with the use of an improved extrusion die, or the use of corn meal in the dough composition and the use of bread crumbs in the filling both in combination with the use of an improved extrusion die provides filled dough products exhibiting particularly advantageous organoleptic properties that may be manufactured in a highly efficient process. Optionally, filled food products utilizing one or more of the above aspects of the present invention may additionally be provided with an outer crispness layer or coating as known in the prior art for further enhancing crispness. Such additional outer coating may, for example, be desired to impart certain textural or flavor properties to the final product.

The dough may be cooked by any conventional method that imparts crispness to the outer surface of the dough shell. Preferably, the dough is fried in oil. Alternatively, the dough may be baked, but since no fat or oil is typically added to the dough during baking, a dough formulation with a higher fat content is used if the product is to be cooked by baking. It is during this cooking step that the dough product attains its desired crispness.

In embodiments of the present invention where the food product comprises projections, the amount of oil absorbed by the projections during frying will depend on the frying time, type of oil used, temperature of the oil, geometry and size of the product, the type of dough used to make the product, the moisture level of the dough, and the temperature of the product as it enters the fryer. The product is fried until it achieves the desired color, degree of cooking, and texture. Preferably, the projections absorb about three to four times as much fat as the main body of the product during frying.

In embodiments of the present invention wherein the dough portion does not contain projections, the dough preferably has about 9 wt-% fat and 31 wt-% moisture after frying. In a preferred embodiment of the product of the present invention, a product made with projections has an overall fat content of about 13 wt-% and a moisture content of about 22 wt-% after frying.

After being cooked, the dough product is packaged for delivery to commercial users of the product, such as restaurants and the like, or for delivery to retail outlets such as grocery stores for subsequent purchase by the home consumer. The dough product is preferably packaged in a manner suited for the particular customer and their projected use. Thus, commercial establishments may prefer to obtain dough products of the present invention in bulk form, while the home consumer may prefer to obtain single product or packaging containing small numbers of product. In a preferred embodiment, the product is provided in a resealable package. In a particularly preferred embodiment, the product of the present invention is provided in packaging appropriate for placement in microwave ovens, and most preferably comprising a microwave susceptor to assist in heating of the product in a microwave oven. A particularly preferred such package is described in copending application U.S. Serial No. [Attorney Docket GMI0007], commonly assigned and filed on Feb. 5, 2003, the disclosure of which is hereby incorporated by reference herein. The dough product of the present invention may be provided as a refrigerated product, or more preferably may be provided in the frozen state. For purposes of the present invention, the term “frozen” describes dough products that are maintained at a temperature below the freezing point of water, regardless of whether all ingredients in the dough product are actually in the frozen state.

The product can be reheated using any conventional method, such as by heating in a conventional oven or by subjecting the product to microwave energy. The product, upon reheating has a crisp, tender dough crust or shell which provides desired organoleptic properties to the product.

All percentages and ratios used herein are weight percentages and ratios unless otherwise indicated.

All publications, patents and patent documents are fully incorporated by reference herein, as though individually incorporated by reference. Numerous characteristics and advantages of the invention meant to be described by this document have been set forth in the foregoing description. It is to be understood, however, that while particular forms or embodiments of the invention have been illustrated, various modifications, including modifications to shape, and arrangement of parts, and the like, can be made without departing from the spirit and scope of the invention.

What is claimed is:

1. A microwaveable dough product containing a filling, said product comprising:
a) pre-cooked dough comprising flour, water, and corn meal dispersed within said dough; and
b) filling comprising crispness maintenance agent, wherein said crispness maintenance agent comprises bread crumbs having an average particle size of from about 1 mm to about 7 mm.

2. The dough product of claim 1, wherein said corn meal is present as from about 2.5 to about 5% by weight of the total dough composition.

3. The dough product of claim 1, wherein said dough comprises titanium dioxide.

4. The dough product of claim 1, wherein said dough product is frozen.

5. The dough product of claim 1, wherein said filling is fully encased in said dough.

6. The dough product of claim 1, wherein said filling comprises a tomato-based sauce.

7. The microwaveable dough product of claim 1, wherein said dough product comprises a main body and a plurality of projections; wherein the projections are formed on an outer surface of the main body, each projection comprising a vertical component extending outwardly from the main body of the dough and a contact area contacting the main body of the dough and wherein not more than about 30% of the surface area of the main body of the dough is contacted by the contact area of the projections and at least about 60% of the total outer surface area of the dough product is in the projections.

8. A microwaveable dough product containing a filling, said product comprising:
a) pre-cooked dough comprising flour, water, and corn meal dispersed within said dough; and
b) filling.

9. A microwaveable dough product containing a filling, said product comprising:
a) pre-cooked dough comprising flour and water; and
b) filling comprising crispness maintenance agent, wherein said crispness maintenance agent comprises bread crumbs having an average particle size of from about 1 mm to about 7 mm.

10. A method for making a dough product capable of attaining crispness upon heating in a microwave oven, comprising:
a) providing an extrusion die having an orifice, the die comprising a plurality of grooves arranged radially along the orifice, wherein each of the grooves is defined by an elongated opening extending radially outwardly from the orifice;
b) preparing a dough comprising flour, water, and corn meal dispersed within said dough;
c) providing a filling comprising crispness maintenance agent, wherein said crispness maintenance agent comprises bread crumbs having an average particle size of from about 1 mm to about 7 mm; and
d) coextruding a volume of the dough through the die to form the dough product comprising a main body and a plurality of projections, together with the filling to form a filled dough product; wherein projections are formed on an outer surface of the main body, each projection comprising a vertical component extending outwardly from the main body of the dough and a contact area contacting the main body of the dough and wherein not more than about 30% of the surface area of the main body of the dough is contacted by the contact area of the projections and at least about 60% of the total outer surface area of the dough product is in the projections.

11. A method for making a dough product capable of attaining crispness upon heating in a microwave oven, comprising:
a) providing an extrusion die having an orifice, the die comprising a plurality of grooves arranged radially along the orifice, wherein each of the grooves is defined by an elongated opening extending radially outwardly from the orifice;
b) preparing a dough comprising flour, water, and corn meal dispersed within said dough;
c) providing a filling; and
d) coextruding a volume of the dough through the die to form the dough product comprising a main body and a plurality of projections, together with the filling to form a filled dough product; wherein projections are formed on an outer surface of the main body, each projection comprising a vertical component extending outwardly from the main body of the dough and a contact area contacting the main body of the dough and wherein not more than about 30% of the surface area of the main body of the dough is contacted by the contact area of the projections and at least about 60% of the total outer surface area of the dough product is in the projections.

12. A method for making a dough product capable of attaining crispness upon heating in a microwave oven, comprising:
a) providing an extrusion die having an orifice, the die comprising a plurality of grooves arranged radially along the orifice, wherein each of the grooves is defined by an elongated opening extending radially outwardly from the orifice;
b) preparing a dough comprising flour and water;
c) providing a filling comprising crispness maintenance agent, wherein said crispness maintenance agent comprises bread crumbs having an average particle size of from about 1 mm to about 7 mm; and.
d) coextruding a volume of the dough through the die to form the dough product comprising a main body and a plurality of projections, together with the filling to form a filled dough product; wherein projections are formed on an outer surface of the main body, each projection comprising a vertical component extending outwardly from the main body of the dough and a contact area contacting the main body of the dough and wherein not more than about 30% of the surface area of the main body of the dough is contacted by the contact area of the projections and at least about 60% of the total outer surface area of the dough product is in the projections.

13. The method of claim 10 and further including cooking the dough product in a fat after extruding the dough and filling.

14. A method for extruding a food product, the method comprising the steps of:
providing an extrusion die comprising a body portion having first and second sides, a primary extrusion opening formed through the body portion and having an outside surface, a plurality of secondary extrusion openings formed through the body portion and spaced apart around the outside surface of the primary extrusion opening and extending outwardly from the outside surface of the primary extrusion opening such that the plurality of secondary extrusion openings fluidly communicate with the primary extrusion opening to form a continuous extrusion opening for forming an extruded food product having a predetermined cross-sectional shape, and at least one recessed region formed in the first side of the body portion including at least a portion of at least one of the plurality of secondary extrusion openings;
providing an extrudable food product; and
extruding the extrudable food product through the continuous extrusion opening of the extrusion die to form an extruded food product having an outside cross-sectional shape generally corresponding with the continuous extrusion opening.

15. The method of claim 14, wherein the step of extruding the food product through the continuous extrusion opening comprises supplying the food product to the first side of the extrusion die.

16. The method of claim 14, wherein the step of extruding the food product through the continuous extrusion opening comprises supplying the food product to the second side of the extrusion die.

17. The method of claim 14, wherein the step of extruding the food product comprises extruding a first food product through the extrusion die to form a food product shell and co-extruding a second food product to substantially fill the food product shell.

18. A food product made by the method of claim 14.

19. A food product extrusion die, the die comprising:
a body portion having first and second sides;
a primary extrusion opening formed through the body portion, the primary extrusion opening having an outside surface;
a plurality of secondary extrusion openings formed through the body portion and spaced apart around the outside surface of the primary extrusion opening and extending outwardly from the outside surface of the primary extrusion opening; and
at least one recessed region in the first side of the body portion including at least a portion of at least one of the plurality of secondary extrusion openings;
wherein the primary extrusion opening and the plurality of secondary extrusion openings form a continuous extrusion opening in the body portion,
which continuous extrusion opening defines an outside cross-sectional shape of a food product extruded from the extrusion die.

20. The extrusion die of claim 19, further comprising at least one recessed region in the second side of the body portion.

21. The extrusion die of claim 19, wherein the at least one recessed region formed in the first side of the body portion comprises a continuous channel formed in the first side of the body portion, which continuous channel includes at least a portion of all of the plurality of secondary extrusion openings.

22. A food product extrusion die, the die comprising:
a body portion having first and second sides;
at least one recessed region formed in the first side of the body portion; and
an extrusion opening comprising:
a primary extrusion opening formed through the body portion, the primary extrusion opening having an outside surface; and
a plurality of secondary extrusion openings formed through at least a portion of the at least one recessed region and formed through the body portion and spaced apart around the outside surface of the primary extrusion opening and extending outwardly from the outside surface of the primary extrusion opening such that the plurality of secondary extrusion openings fluidly communicate with the primary extrusion opening and the at least one recessed region.

23. The extrusion die of claim 22, wherein at least one of the plurality of secondary extrusion openings comprises a first portion radially outwardly extending from the outside surface of the primary extrusion opening and a second portion in fluid communication with the first portion generally perpendicularly disposed with respect to the first portion.

24. The extrusion die of claim 23, wherein the second portion of the at least one of the plurality of secondary extrusion openings comprises an arch shaped opening through the body portion of the extrusion die.

25. The extrusion die of claim 22, wherein the at least one recessed region formed in the first side of the body portion completely includes at least one of the plurality of secondary extrusion openings.

26. The extrusion die of claim 25, further comprising an individual recessed region including at least a portion of each individual secondary extrusion opening of the plurality of secondary extrusion openings.

27. The extrusion die of claim 22, in combination with an extrusion device.

28. The combination of claim 27, wherein the extrusion device comprises a coextrusion device for extruding a first food product through the extrusion opening of the extrusion die to form an extruded food product shell and for extruding a second food product to fill the extruded food product shell to form a filled food product.

29. A method for making a dough product capable of attaining crispness upon heating in a microwave oven, comprising:
a) providing an extrusion die comprising a body portion having first and second sides, a primary extrusion opening formed through the body portion and having an outside surface, a plurality of secondary extrusion openings formed through the body portion and spaced apart around the outside surface of the primary extrusion opening and extending outwardly from the outside surface of the primary extrusion opening such that the plurality of secondary extrusion openings fluidly communicate with the primary extrusion opening to form a continuous extrusion opening for forming an extruded food product having a predetermined cross-sectional shape, and at least one recessed region formed in the first side of the body portion including at least a portion of at least one of the plurality of secondary extrusion openings;
b) preparing a dough comprising flour, water, and corn meal dispersed within said dough;
c) providing a filling comprising crispness maintenance agent, wherein said crispness maintenance agent comprises bread crumbs having an average particle size of from about 1 mm to about 7 mm; and
d) coextruding a volume of the dough through the die together with the filling to form a filled dough product to form an extruded food product having an outside cross-sectional shape generally corresponding with the continuous extrusion opening.

30. A method for making a dough product capable of attaining crispness upon heating in a microwave oven, comprising:
a) providing an extrusion die comprising a body portion having first and second sides, a primary extrusion opening formed through the body portion and having an outside surface, a plurality of secondary extrusion openings formed through the body portion and spaced apart around the outside surface of the primary extrusion opening and extending outwardly from the outside surface of the primary extrusion opening such that the plurality of secondary extrusion openings fluidly communicate with the primary extrusion opening to form a continuous extrusion opening for forming an extruded food product having a predetermined cross-sectional shape, and at least one recessed region formed in the first side of the body portion including at least a portion of at least one of the plurality of secondary extrusion openings;
b) preparing a dough comprising flour, water, and corn meal dispersed within said dough;
c) providing a filling; and
d) coextruding a volume of the dough through the die together with the filling to form a filled dough product to form an extruded food product having an outside cross-sectional shape generally corresponding with the continuous extrusion opening.

31. A method for making a dough product capable of attaining crispness upon heating in a microwave oven, comprising:
a) providing an extrusion die comprising a body portion having first and second sides, a primary extrusion opening formed through the body portion and having an outside surface, a plurality of secondary extrusion openings formed through the body portion and spaced apart around the outside surface of the primary extrusion opening and extending outwardly from the outside surface of the primary extrusion opening such that the plurality of secondary extrusion openings fluidly communicate with the primary extrusion opening to form a continuous extrusion opening for forming an extruded food product having a predetermined cross-sectional shape, and at least one recessed region formed in the first side of the body portion including at least a portion of at least one of the plurality of secondary extrusion openings;
b) preparing a dough comprising flour and water;
c) providing a filling comprising crispness maintenance agent, wherein said crispness maintenance agent comprises bread crumbs having an average particle size of from about 1 mm to about 7 mm; and
d) coextruding a volume of the dough through the die together with the filling to form a filled dough product to form an extruded food product having an outside cross-sectional shape generally corresponding with the continuous extrusion opening.
